(19) United States
(12) Patent Application Publication
(10) Pub. No.: US 2026/0220769 A1
(43) Pub. Date: Jul. 30, 2026

(54) ORGANIC DEFECT SOURCE IDENTIFICATION USING ARTIFICIAL INTELLIGENCE

(71) Applicant: Applied Materials, Inc., Santa Clara, CA (US)

(72) Inventors: Yuanhong Guo, Mountain View, CA (US); Tianyuan Wu, San Jose, CA (US); Wenxuan Qiu, Santa Clara, CA (US); Rohith Cherikkallil, Kerala (IN); Rahul Reddy Komatireddi, Telangana (IN); Sachin Dangayach, San Jose, CA (US); Yun-Ting Sun, San Jose, CA (US)

(21) Appl. No.: 19/038,345

(22) Filed: Jan. 27, 2025

(51) Int. Cl. G06T 7/00; G06F 9/451; G06T 5/60; G06T 5/77

(52) U.S. Cl. CPC G06T 7/0012; G06F 9/451; G06T 5/60; G06T 5/77

(57) ABSTRACT

Methods and systems for organic defect source identification using artificial intelligence (AI) are provided. One or more images depicting a surface of a substrate processed using one or more manufacturing equipment is provided as input to an artificial intelligence (AI) model. Output(s) of the AI model is obtained, where the output(s) indicate defect characterization data associated with a defect detected on the surface of the substrate depicted by the one or more images. A determination is made of whether a level of confidence of at least one defect type and associated defect source from the defect characterization data satisfies one or more confidence criteria. Upon a determination that at least one defect type and associated defect source satisfy the one or more confidence criteria, the at least one defect type and associated defect source are provided to a client device for presentation to one or more users.

### TECHNICAL FIELD

Embodiments of the present disclosure relate, in general, to manufacturing systems and more particularly to systems and methods for organic defect source identification using artificial intelligence (AI).

### BACKGROUND

Defect identification and classification can be performed to ensure that manufacturing systems are maximizing yield and producing quality substrates. However, organic defects can be difficult to identify and classify due to their transparent nature, which prevents the organic defect from being visible in images captured using standard imaging techniques (e.g., visible light imaging). Additionally, organic defects can share similar chemical compositions to other organic materials on the surface of the substrate (e.g., polymers), making detection and identification difficult. As such, identification and classification of organic defects can include lengthy multi-step processes that involve human inspection.

### SUMMARY

Some of the embodiments described cover organic defect source identification using artificial intelligence (AI). The method includes identifying one or more images depicting a surface of a substrate processed using one or more manufacturing equipment. The method further includes providing the one or more images as an input to an artificial intelligence (AI) model. The method further includes obtaining one or more outputs of the AI model. The one or more outputs include defect characterization data associated with a defect detected on the surface of the substrate depicted by the one or more images. The defect characterization data includes an indication of a set of defect types and, for each respective defect type of the set of defect types, an indication of a defect source at the one or more manufacturing equipment in view of the respective defect type, and for each of the set of defect types, a level of confidence that the respective defect type and associated defect source correspond to the defect on the surface of the substrate. The method further includes, responsive to determining that the level of confidence associated with at least one respective defect type and associated defect source satisfies one or more confidence criteria, providing, to a client device, the indication of the at least one respective defect type and associated defect source for presentation to one or more users.

In some implementations, the method further includes, prior to providing the one or more images as the input to the AI model, performing one or more preprocessing operations on the one or more images. The preprocessing operations include at least one of increasing a resolution of the one or more images or removing one or more of text, patterns, burnout marks, or particles depicted by the one or more images.

In some implementations, a respective preprocessing operation of the one or more preprocessing operations is associated with a separate AI model trained to perform one or more tasks pertaining to the respective preprocessing operation.

In some implementations, the method further includes providing a user interface (UI) for the client device for presentation to the one or more users. The UI includes one or more UI elements each corresponding to a respective preprocessing operation of the one or more preprocessing operations. The respective preprocessing operation of the one or more preprocessing operations is performed responsive to detection of a user selection of a corresponding UI element of the one or more UI elements.

In some implementations, the one or more images includes scanning electron microscopy (SEM) images.

In some implementations, the method further includes determining an ordering associated with each of the set of defect types and associated defect source based on the level of confidence for each respective defect type and associated defect source. Each of the set of defect types and associated defect source are provided for presentation to the one or more users in accordance with the determined ordering.

In some implementations, the defect is an organic defect.

In some implementations, the method further includes determining one or more defect correction operations to be performed to correct the defect based on the at least one respective defect type and the associated defect source. The method further includes providing an indication of the determined one or more defect correction operations to the client device for presentation to the one or more users.

In some implementations, the method further includes determining, based on the indication of the at least one respective defect type and the associated defect source, that one or more process termination criteria are satisfied. The method further includes performing one or more operations to terminate a substrate process for the substrate or one or more additional substrates at the one or more manufacturing equipment.

In some implementations, a system includes a memory and a set of one or more processing devices coupled to the memory. The set of one or more processing devices is to generate training data for training an artificial intelligence (AI) model to predict current defect characterization data for a defect detected on a surface of a current substrate depicted by current images of the current substrate processed using one or more first manufacturing equipment. To generate the training data, the set of one or more processing devices is to generate a training input comprising one or more historical images depicting a historical defect on a surface of a historical substrate processed using one or more second manufacturing equipment. The set of one or more processing devices is further to generate a target output for the training input. The target output includes historical defect characterization data. Defect characterization data includes an indication of a defect type for the historical defect and an indication of a defect source associated with the historical defect at the one or more second manufacturing equipment in view of the defect type. The set of one or more processing devices is further to provide the training data to train the AI model on (i) a set of training inputs comprising the training input and (ii) a set of target outputs comprising the target output.

In some implementations, the, the set of one or more processing devices is further to extract, from metadata associated with the one or more historical images, one or more image descriptors of the one or more historical images. The set of one or more processing devices is further to identify one or more image descriptors associated with one or more defect types. The set of one or more processing devices is further to determine, based on the one or more image descriptors of the one or more historical images and the one or more image descriptors of the one or more defect types, the defect type for the historical defect and an associated source of the historical defect in view of the defect type.

In some implementations, the defect type is one of a lubricant, photoresist residue, cleaning solvent residue, chemical solvent residue, a polymer film, a chemical vapor, or an airborne contaminant.

In some implementations, the defect source is one of a robot adaptor, a diffusion tool, a packaging tool, a hot plate, a lithography tool, a cleaning tool, a deposition tool, a metrology tool, or an etching tool.

In some implementations, the one or more historical images are preprocessed. The preprocessing includes at least one of increasing a resolution of the one or more images or removing one or more of text, patterns, burnout marks, or particles depicted by the one or more images.

In some implementations, the historical defect is an organic defect.

In some implementations, the one or more historical images further include SEM images.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 depicts an illustrative system architecture, according to aspects of the present disclosure.

FIG. 2 is a block diagram of an example defect identification (ID) engine, according to aspects of the present disclosure.

FIG. 3 is a flow chart of an example method for training an artificial intelligence (AI) model, according to aspects of the present disclosure.

FIG. 4 is a flow chart of an example method for organic defect source identification using AI, according to aspects of the present disclosure.

FIG. 5 depicts a block diagram of an illustrative computer system operating in accordance with one or more aspects of the present disclosure.

### DETAILED DESCRIPTION OF EMBODIMENTS

Implementations described herein provide systems and methods for organic defect source identification using artificial intelligence (AI). In semiconductor manufacturing, a defect can occur or be otherwise formed on a surface of a substrate based on compounds or particles present in manufacturing equipment that processes the substrate. An organic defect refers to a substrate defect caused by organic materials, or compounds that primarily consist of carbon and hydrogen (e.g., hydrocarbons, residual polymers of photoresist, or organic cleaning materials). The presence of an organic defect on a substrate can create an uneven surface on the substrate, which can prevent chemical or mechanical reactions from occurring on the substrate surface (e.g., during a substrate process). The uneven surface and/or other abnormalities caused by an organic defect can cause poor adhesion on the substrate surface during subsequent processing steps. Additionally, the organic defect on the surface of a substrate can cause an increased electrical resistance, short circuits, and long-term degradation on the surface of the substrate.

Unlike other types of defects, organic defects are more difficult to detect because they can form thin, transparent films or stains on the surface of a substrate. Such films are not immediately detectable as structural or visual anomalies and more thorough inspection may be performed to detect organic defects than is performed to detect other types of defects, such as scratches or cracks (e.g., which may be more readily apparent). Organic defects can also vary in size, shape, and depth, making such defects difficult to classify, as different types of organic defects may share similar characteristics. For example, both a stain on a surface of a substrate caused by a cleaning solvent and a film formed via a volatile organic compound (e.g., isopropyl alcohol (IPA), toluene, acetone, etc.) may appear as one or more streaks on the substrate surface, making it difficult for a system to accurately determine the type of organic defect. In contrast, other types of defects can usually be classified based on the size, shape, and location of the defect, making them easier to classify. For example, a scratch appearing as a line or dent on the surface of the substrate is easily differentiable from condensate that appears as a spherical particle on the surface of the substrate.

Additionally, organic defects can originate from one or more of multiple sources at manufacturing equipment, making it difficult to determine a source of the organic defect. For example, an organic film can be caused based on improper gas distribution of a diffusion tool, failure of a cleaning tool to remove cleaning solvent residue, lubricants on a robotic arm, and so forth. In comparison, other types of defects can be easier to classify, as such defects can have more apparent causes, such as scratches from handling or particles from deposition equipment. As such, detecting organic defects and identifying the defect source can involve a more detailed inspection of the defect and understanding of the manufacturing process and materials used in order to determine the source of the defect.

Conventional systems use specialized equipment to perform techniques such as Fourier-transform infrared spectroscopy (FTIR), mass spectrometry, or ellipsometry to detect the presence of organic materials on the surface of the substrate. Such techniques can involve composition analysis, where the equipment identifies and characterizes the chemical components on the surface of the substrate to determine whether a defect is present. For example, FTIR equipment can detect molecular vibrations and light absorption at different wavelengths to identify specific chemical bonds and the concentration of known chemical compounds. However, organic materials that cause different types of organic defects may be composed of similar atoms, such as carbon, hydrogen, oxygen, and nitrogen, which can form similar functional groups (e.g., hydroxyl, carbonyl, or methyl) that are detected by FTIR equipment as overlapping signals. Such overlapping signals can make it difficult for FTIR equipment (or other equipment or detection systems) to distinguish between the different types of chemical compounds that can cause different types of organic defects. Once this occurs, manual inspection (e.g., by an operator or engineer of a system) is performed to determine whether an organic defect is present. However, manual inspection of a substrate is prone to human error based on the perception and the experience of the inspector. Additionally, in order for the operator or engineer to manually inspect the substrate, the substrate is removed from the manufacturing equipment of which the substrate was processed, which can involve removing the substrate from a vacuum environment and exposing the substrate to the factory environment. By removing the substrate from the vacuum environment, the substrate is exposed to particles and other debris present in the factory environment, making the substrate unusable for its intended purpose, which decreases an overall throughput of the manufacturing system.

Another conventional solution involves the system obtaining high-resolution images of the surface of a substrate (e.g., using scanning electron microscopy (SEM) equipment) and determining a morphology and/or a structure of features of the substrate surface, as depicted by the high-resolution images. However, such techniques still involve manual inspection of the high-resolution images to determine, based on the morphology and/or the structure of the substrate surface features, whether an organic defect is present. As discussed above, such manual inspection can be prone to human error (e.g., the developer or engineer may incorrectly characterize a target surface feature as an organic defect and/or may incorrectly characterize an organic defect as a target surface feature). For example, high-resolution images obtained using SEM equipment can depict features of a substrate surface as one or more feature clusters, such as particle clusters or defect clusters. Based on the manual inspection of the images, it may be difficult to distinguish between organic defects and the target features of the substrate surface. Obtaining high-resolution images of a substrate surface and analyzing such images to determine the morphology and/or structure of features of the substrate surface can take a significant amount of time and consume a large amount of computing resources (e.g., processing cycles, memory space, etc.). If an organic defect is not accurately identified and/or characterized based on the manual inspection, such consumed computing resources may be wasted, which decreases an overall efficiency and increases an overall latency of the system.

Further, the failure to accurately classify defects can lead to a higher number of processed substrates that are deemed defective or fail to meet manufacturing quality standards. If a defect present on a surface of a substrate is improperly classified, unnecessary resources may be spent correcting noncritical issues without addressing the real source of the defect. For example, due to improper classification of a defect, computing resources may be consumed to analyze and recalibrate process parameters of a manufacturing tool, when the real source of the defect may correspond to a noncritical issue that ultimately has a negligible impact on the overall performance of the manufacturing tool. The failure to address the real source of the defect can cause the defect to be reproduced on subsequently processed substrates, decreasing the overall yield of the system. The unnecessary costs incurred to fix non-issues and the decreased yield due to the failure to correct the source of the defect can cause a significant amount of time and resources (e.g., computing resources, substrate materials, chemical cleaning agents, etc.) to be consumed to process substrates to meet manufacturing system specifications (e.g., yield targets for substrates that meet the manufacturing quality standards). The additional time and resources spent to meet the manufacturing system specifications can decrease the overall efficiency and throughput of the manufacturing system.

Aspects of the present disclosure address the above noted and other deficiencies by providing systems and methods for organic defect detection using AI techniques. A system can train an AI model (e.g., a machine learning model) to predict whether a defect is present on the surface of a substrate based on a given image depicting the surface of the substrate. If a defect is detected, the AI model can predict defect characterization data for the detected defect based on the given image. Defect characterization data can include an indication of a defect type and/or an indication of a source of the defect at one or more manufacturing equipment in view of the defect type. A defect type can include, for example, lubricants, photoresist residue, cleaning solvent residue, or airborne contaminants (e.g., outgassing materials or volatile organic compounds present in a manufacturing chamber that settle on the surface of a substrate) present on the surface of a substrate. Such defects can be caused based on operation of a robot adaptor, a diffusion tool, a hot plate, a packaging tool, a lithography tool, a cleaning tool, an etching tool, and so forth before and/or during a substrate process.

In some instances, the AI model can be trained using training data that includes a set of training inputs and a set of target outputs. A training input can include one or more historical images depicting a historical defect on a surface of a historical substrate processed using one or more manufacturing equipment (e.g., of the manufacturing system or of another manufacturing system). A target output of the training input can include historical defect characterization data (e.g., a defect type of the historical defect, a source of the historical defect, etc.) obtained for the one or more historical images depicting the historical defect. In some embodiments, the historical defect characterization data can be provided by an operator of the system. Further details regarding training the AI model are provided herein.

Upon training the AI model, the AI model can be applied to one or more images depicting a substrate processed at a manufacturing system. For example, the system can identify one or more images depicting a defect on a surface of a substrate processed using one or more manufacturing equipment and can provide the one or more images as an input to the trained AI model. In some embodiments, one or more preprocessing operations can be performed with respect to increasing the image resolution and/or removing noise (e.g., text, patterns and burnout marks caused by electron beams (eBeams), or other particles on the substrate) from the image(s). The system can obtain one or more outputs of the AI model, which can include defect characterization data associated with the defect depicted by the one or more images. The defect characterization data includes an indication of a one or more defect types, and, for each respective defect type, an indication of a defect source at the manufacturing equipment in view of the respective defect type. Each defect type can also be associated with a level of confidence that the respective defect type and associated defect source correspond to the defect on the surface of the substrate, as depicted by the image(s). The system can determine whether a defect type and associated defect source satisfy one or more confidence criteria (e.g., by determining whether a level of confidence associated with a respective defect type and associated defect source exceed a level of confidence threshold or is larger than levels of confidence for other defect types and associated defect sources).

Upon determining that a defect type and associated defect source satisfy the one or more confidence criteria, the system can provide an indication of the defect type and the associated defect source to a client device for presentation to one or more users. In some embodiments, the system may determine one or more defect correction operations to be performed based on the indicated defect types and associated defect source. In other or similar embodiments, the system may terminate a substrate process at the one or more manufacturing equipment if the indicated one or more defect types and/or associated defect source satisfy one or more process termination criteria.

Aspects of the present disclosure address the above noted and other deficiencies by providing techniques for detecting organic defects and identifying the source of the detected organic defects using AI. As described herein, an AI model can be trained to predict defect characterization data associated with a detected defect on a surface of a substrate processed using manufacturing equipment based on one or more given images of the surface of the substrate. Accordingly, the system can detect the defects based on image data, which improves the likelihood of identifying the organic defect (e.g., compared to composition analysis techniques or other such techniques). Additionally, by obtaining the defect characterization data based on the one or more outputs of the AI model, an operator or engineer does not perform manual inspection of substrate and/or substrate images, which reduces overall inspection time and the likelihood of human error in the diagnosis. In view of the above, embodiments of the present disclosure enable the system to determine the defect type and source of an organic defect on the surface of a substrate with improved accuracy and therefore apply an appropriate correction to manufacturing equipment in a shorter amount of time, which improves an overall efficiency, latency, and throughput of the system.

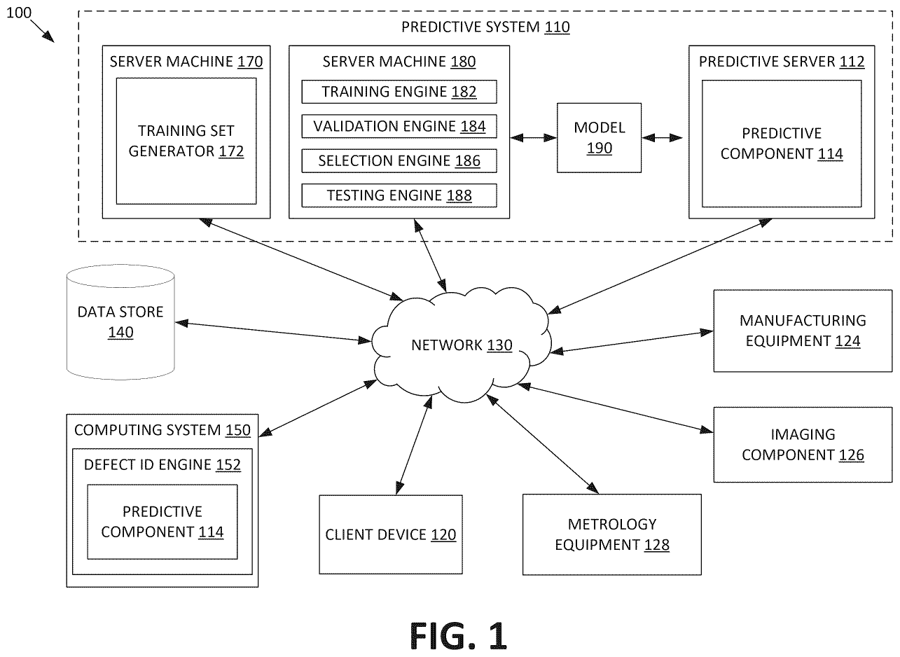

FIG. 1 depicts an illustrative system architecture 100, according to aspects of the present disclosure. System architecture 100 can include a client device 120, manufacturing equipment 124, metrology equipment 128, a predictive server 112 (e.g., to generate predictive data, to provide model adaptation, to use a knowledge base, etc.), and/or a data store 140. The predictive server 112 can be part of a predictive system 110. The predictive system 110 can further include server machines 170 and 180. In some embodiments, system architecture 100 can be included as part of or otherwise connected to a manufacturing system for processing substrates.

Manufacturing equipment 124 can produce products, such as electronic devices, following a recipe or performing runs over a period of time. Manufacturing equipment 124 can include a process chamber. Manufacturing equipment 124 can perform a process for a substrate (e.g., a wafer, etc.) at the process chamber. Examples of substrate processes include a deposition process to deposit a film on a surface of the substrate, an etch process to form a pattern on the surface of the substrate, a polishing process to polish a material on the surface of the substrate, etc. Manufacturing equipment 124 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc. Substrates that are processed according to a process recipe (e.g., for manufacturing a portion of an electronic device, etc.) are referred to herein as production substrates.

Manufacturing equipment 124 can include one or more sensors that capture data for a substrate being processed at the manufacturing system. In some embodiments, the manufacturing equipment 124 and the sensors can be part of a sensor system that includes a sensor server (e.g., field service server (FSS) at a manufacturing facility) and sensor identifier reader (e.g., front opening unified pod (FOUP) radio frequency identification (RFID) reader for sensor system). Sensor data may include a value of one or more of temperature (e.g., heater temperature), spacing (SP), pressure, high frequency radio frequency (HFRF), RF bias, voltage of electrostatic chuck (ESC), electrical current, flow, power, voltage, etc. Sensor data may be associated with or indicative of manufacturing parameters such as hardware parameters, such as settings or components (e.g., size, type, etc.) of the manufacturing equipment 124, or process parameters of the manufacturing equipment 124. The sensor data can be provided while the manufacturing equipment 124 is performing manufacturing processes (e.g., equipment readings when processing products). The sensor data 142 can be different for each substrate. In some embodiments, sensor data can include trace data collected during performance of one or more processes (e.g., substrate processes, maintenance processes, etc.) at manufacturing equipment 124. Trace data refers to data that indicates how components in a process chamber are operating and/or a state of an environment within a process chamber before, during, or after performance of an operation.

Manufacturing equipment 124 can include an inspection station where substrates are inspected after being processed in the process chamber. In some embodiments, the inspection station can be located at or included in a process tool of manufacturing equipment 124. A process tool refers to or can include specialized manufacturing equipment located in a processing chamber that performs fabrication steps (e.g., deposition) on substrates. In some embodiments, the inspection station can be located in the vacuum environment of the process tool. In other embodiments, the inspection station can be located outside the vacuum environment (e.g., as external equipment from the process tool).

Metrology equipment 128 provides metrology data associated with substrates (e.g., production substrates, seasoning substrates, etc.) processed by manufacturing equipment 124. The metrology data can include a value of one or more of film property data (e.g., wafer spatial film properties), dimensions (e.g., thickness, height, etc.), dielectric constant, dopant concentration, density, defects, etc. In some embodiments, the metrology data can further include a value of one or more surface profile property data (e.g., an etch rate, an etch rate uniformity, a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology equipment 128 can be configured to generate metrology data associated with a substrate before or after a substrate process and/or a maintenance process. In some embodiments, metrology equipment 128 can be part of a metrology system that includes a metrology server (e.g., a metrology database, metrology folders, etc.) and metrology identifier reader (e.g., FOUP RFID reader for metrology system).

Metrology equipment 128 can be integrated with a station of the process tool of manufacturing equipment 124. In some embodiments, metrology equipment 128 can be coupled to or be a part of a station of the process tool that is maintained under a vacuum environment (e.g., a process chamber, a transfer chamber, etc.). Such metrology equipment 128 is referred to as integrated metrology equipment. Accordingly, the substrate can be measured by the integrated metrology equipment while the substrate is in the vacuum environment. For example, after a process (e.g., an etch process, a deposition process, etc.) is performed for the substrate, the metrology data for the substrate can be generated by the integrated metrology equipment without the processed substrate being removed from the vacuum environment. In other or similar embodiments, metrology equipment 128 can be coupled to or be a part of the process tool station that is not maintained under a vacuum environment (e.g., a factory interface module, etc.). Such metrology equipment is referred to as inline metrology equipment. Accordingly, the substrate is measured by the inline metrology equipment outside of the vacuum environment.

In additional or alternative embodiments, metrology equipment 128 can include metrology measurement devices that are separate (i.e., external) from manufacturing equipment 124. For example, metrology equipment 128 can be standalone equipment that is not coupled to any station of manufacturing equipment 124. For a measurement to be obtained for a substrate using external metrology equipment, a user of a manufacturing system (e.g., an engineer, an operator) can cause a substrate processed at manufacturing equipment 124 to be removed from manufacturing equipment 124 and transferred to metrology equipment 128 for measurement. In some embodiments, metrology equipment 128 can transfer metrology data generated for the substrate to the client device 120 coupled to metrology equipment 128 via network 130 (e.g., for presentation to a manufacturing user, such as an operator or an engineer). In other or similar embodiments, the manufacturing system user can obtain metrology data for the substrate from metrology equipment 128 and can provide the metrology data to computer system architecture via a graphical user interface (GUI) of client device 120.

The client device 120 my include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. In some embodiments, the metrology data may be received from the client device 120. In some embodiments, client device 120 displays a graphical user interface (GUI), where the GUI enables the user to provide, as input, metrology measurement values for substrates processed at the manufacturing system. In other or similar embodiments, client device 120 can display another GUI that enables the user to provide, as input, an indication of a type of substrate to be processed at the manufacturing system, a type of process to be performed for the substrate, and/or a type of equipment at the manufacturing system. In yet other or similar embodiments, client device 120 can display another GUI that that presents sensor data collected by the sensors before, during, or after performance of a process (e.g., a substrate process, a maintenance process, etc.). It should be noted that one or more GUIs of client device 120 can provide and/or receive any data described herein.

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). The data store 140 can store data associated with processing a substrate at manufacturing equipment 124. For example, data store 140 can store data collected by the sensors at manufacturing equipment 124 before, during, or after a substrate process (referred to as process data). Process data can refer to historical process data (e.g., process data generated for a previous substrate processed at the manufacturing system) and/or current process data (e.g., process data generated for a current substrate processed at the manufacturing system). Current process data can be data for which predictive data is generated. In some embodiments, data store can store metrology data including historical metrology data (e.g., metrology measurement values for a prior substrate processed at the manufacturing system). The data store 140 can also store contextual data associated with one or more substrates processed at the manufacturing system. Contextual data can include a recipe name, recipe operation number, preventive maintenance indicator, operator, etc. In some embodiments, contextual data can also include an indication of a difference between two or more process recipes or process operations. In some embodiments, data store 140 can additionally or alternatively store image data collected for a substrate before, during, or after processing of the substrate, as described herein.

In some embodiments, data store 140 can be configured to store data that is not accessible to a user of the manufacturing system. For example, process data, spectral data, non-spectral data, and/or positional data obtained for a substrate being processed at the manufacturing system may not be accessible to a user of the manufacturing system. In some embodiments, all data stored at data store 140 is inaccessible by a user (e.g., an operator) of the manufacturing system. In other or similar embodiments, a portion of data stored at data store 140 is inaccessible by the user while another portion of data stored at data store 140 is accessible by the user. In some embodiments, one or more portions of data stored at data store 140 are encrypted using an encryption mechanism that is unknown to the user (e.g., data is encrypted using a private encryption key). In other or similar embodiments, data store 140 includes multiple data stores where data that is inaccessible to the user is stored in one or more first data stores and data that is accessible to the user is stored in one or more second data stores.

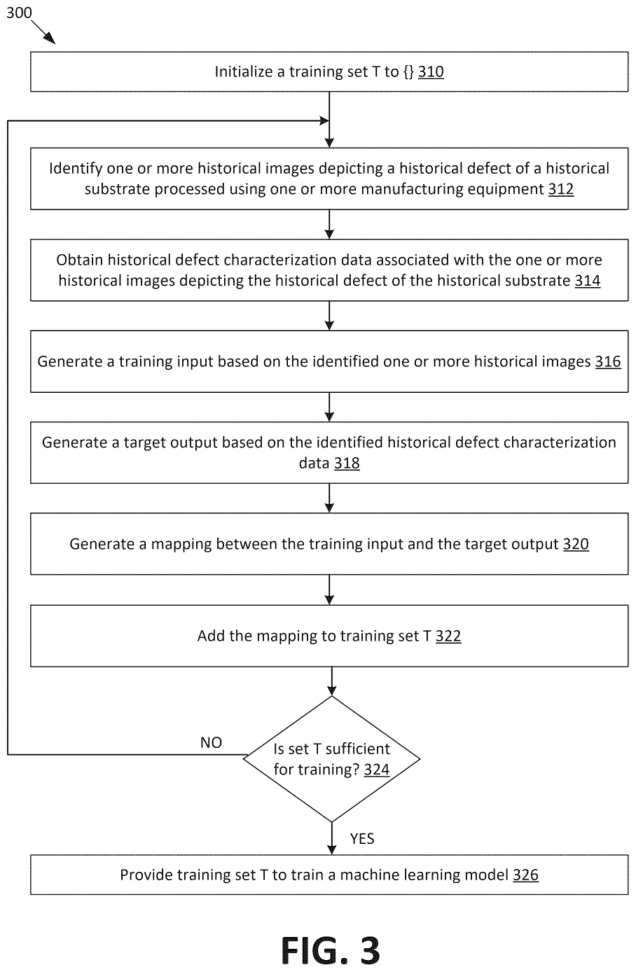

Computing system 150 can include a defect identification (ID) engine 152 that detects defects present on the surface of a substrate and/or identifies a defect type and defect source for detected defects by applying an AI model (e.g., model 190) to one or more images (e.g. scanning electron microscopy (SEM) images, or high-resolution images obtained using SEM equipment) of the surface of a substrate. The defect ID engine 152 can obtain one or more images depicting a surface of a substrate. In some embodiments, detect ID engine 152 can obtain the image(s) based on an imaging component 126 that captures the image(s) of the surface of the substrate. Imaging component 126 can be included in a processing chamber or located outside the processing chamber (e.g., at an inspection station separate from the processing chamber). The defect ID engine 152 can provide the one or more images to the model 190 trained to provide defect characterization data based on given images depicting a surface of a substrate. In some embodiments, defect ID engine 152 can include or have access to a predictive component 114 (e.g., of predictive system 110) which provides the one or more images depicting the surface of the substrate as an input to the model 190. In other or similar embodiments, predictive system 110 can train the model 190 to predict defect characterization data, as described below with respect to FIG. 3.

Defect characterization data can include an indication of whether an organic defect is present on the surface of a substrate. An organic defect is a defect caused by the presence of organic materials (e.g., carbon-based compounds) on the surface of a substrate, such as lubricants, photoresist residue, cleaning solvent residue, polymer films, or chemical vapor (e.g., volatile organic compounds) settled on the surface of the substrate. In some embodiments, the defect characterization data can indicate a set of defect types and, for each respective defect type, an indication of a defect source at the manufacturing equipment 124 in view of the defect type, and, for each defect type and associated defect source, a level of confidence that the respective defect type and associated defect source correspond to the defect detected on the surface of the substrate. For example, the predictive component 114 can provide one or more images depicting a surface feature (e.g., a stain) on a surface of a substrate and the model 190 will indicate whether the surface feature corresponds to a defect and provide defect characterization data for the depicted surface feature. It should be noted that although some embodiments and examples of the present disclosure are directed to organic defects formed on the surface of a substrate, embodiments and examples of the present disclosure can be applied to other types of defects, such as an inorganic defect. For purposes of example and explanation only, some embodiments and examples of the present disclosure refer to a defect present on a surface of a substrate, where such defect can include an organic defect or an inorganic defect.

The predictive component 114 can determine whether the defect is present on the surface of a substrate by determining whether the model 190 indicates that a defect is present based on images of the surface of the substrate. In some embodiments, the predictive component 114 can determine that a defect is present by determining whether the confidence level of a defect type and associated defect source output by the model 190 satisfy confidence criteria. If the surface feature is determined to be a defect, the predictive component 114 can determine one or more defect types and defect sources for the detected defect based on the confidence levels of each indicated defect type and defect source. For example, the predictive component 114 can identify the defect types and defect sources with confidence levels that satisfy the same and/or additional confidence criteria. In some embodiments, the defect ID engine 152 can order the one or more defect types and associated defect source based on a level of confidence that the defect type and associated defect source correspond to the one or more images of the defect on the surface of the substrate.

The computing system 150 can provide the indication of whether the surface of the substrate contains a defect and the one or more defect types and defect sources to a client device 120. In some embodiments, the defect ID engine 152 can determine one or more defect correction operations based on the indicated defect types and defect sources, which the computing system 150 can provide to the client device 120. In other or similar embodiments, the defect ID engine can determine if the indicated defect types and defect sources satisfy one or more process termination criteria. If the process termination criteria are satisfied, then the computing system 150 can terminate a substrate process at the manufacturing equipment 124.

In some embodiments, predictive system 110 includes server machine 170 and server machine 180. Server machine 170 includes a training set generator 172 that is capable of generating training data sets (e.g., a set of data inputs and a set of target outputs) to train, validate, and/or test an AI model 190. Some operations of training set generator 172 are described in detail below with respect to FIG. 3. In some embodiments, the training set generator 172 can partition the training data into a training set, a validating set, and a testing set. In some embodiments, the predictive system 110 generates multiple sets of training data.

Server machine 180 includes a training engine 182, a validation engine 184, a selection engine 186, and/or a testing engine 188. An engine can refer to hardware (e.g., circuitry, dedicated logic, programmable logic, microcode, processing device, etc.), software (such as instructions run on a processing device, a general purpose computer system, or a dedicated machine), firmware, microcode, or a combination thereof. Training engine 182 can be capable of training an AI model 190. The AI model 190 can refer to the model artifact that is created by the training engine 182 using the training data that includes training inputs and corresponding target outputs (correct answers for respective training inputs). The training engine 182 can find patterns in the training data that map the training input to the target output (the answer to be predicted), and provide the patterns to the AI model 190 that captures these patterns. In some embodiments, the AI model 190 uses one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network, a recurrent neural network, a convolutional neural network, etc.), clustering techniques (e.g., hierarchical clustering techniques), association techniques (e.g., apriori techniques), classification techniques (e.g., decision trees, random forest techniques, etc.), a variational recurrent auto-encoder, etc. It should be noted that although some embodiments of the present disclosure describe model 190 as an AI model, such embodiments can be applied to any type of AI model, non-AI based model (e.g., a statistical model, a physical model, etc.), and/or a hybrid model (e.g., implementing AI techniques and non-AI techniques).

The validation engine 184 can be capable of validating a trained AI model 190 using a corresponding set of features of a validation set from training set generator 172. The validation engine 184 can determine an accuracy of each of the trained AI models 190 based on the corresponding sets of features of the validation set. The validation engine 184 can discard a trained AI model 190 that has an accuracy that does not meet a threshold accuracy. In some embodiments, the selection engine 185 can be capable of selecting a trained AI model 190 that has an accuracy that meets a threshold accuracy. In some embodiments, the selection engine 185 can be capable of selecting the trained AI model 190 that has the highest accuracy of the trained AI models 190.

The testing engine 186 can be capable of testing a trained AI model 190 using a corresponding set of features of a testing set from training set generator 172. For example, a first trained AI model 190 that was trained using a first set of features of the training set can be tested using the first set of features of the testing set. The testing engine 186 can determine a trained AI model 190 that has the highest accuracy of all of the trained AI models based on the testing sets.

Predictive server 112 includes a predictive component 114 that is capable of providing data as an input to a trained model 190 and obtaining one or more outputs of the trained model 190. As described herein, predictive component 114 can be a component of or otherwise associated with defect ID engine 152 and can provide one or more images of a surface of a substrate (e.g., an SEM image of a stain from cleaning solvent residue) as an input to trained model 190. In some embodiments, the image(s) may depict a defect on the surface of the substrate. For example, defect ID engine 152 may identify, based on a set of images generated for one or more substrates processed using manufacturing equipment 124, a particular image depicting a defect and may select such image to be provided as an input to the AI model 190. Defect ID engine 152 may identify the particular image as depicting the defect based on an indication provided by a user (e.g., an operator, an engineer, etc.) of manufacturing equipment 124 and/or otherwise associated with system 100, in some embodiments. In other or similar embodiments, it may not be known or otherwise determined whether a surface feature of a substrate depicted in the one or more images is a defect. Predictive component 114 can obtain one or more outputs of trained model 190, which can include defect characterization data associated with a defect depicted in the one or more images, as described herein. In some embodiments, defect characterization data can include an indication of whether the surface feature depicted in the one or more images corresponds to a defect.

As illustrated by FIG. 1, the client device 120, manufacturing equipment 124, metrology equipment 128, predictive server 112, data store 140, server machine 170, and server machine 180 can be coupled to each other via a network 130. In some embodiments, network 130 is a public network that provides client device 120 with access to predictive server 112, data store 140, and other publicly available computing devices. In some embodiments, network 130 is a private network that provides client device 120 access to manufacturing equipment 124, metrology equipment 128, data store 140, and other privately available computing devices. Network 130 can include one or more wide area networks (WANs), local area networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof.

It should be noted that in some other implementations, the functions of server machines 170 and 180, as well as predictive server 112, can be provided by a fewer number of machines. For example, in some embodiments, server machines 170 and 180 can be integrated into a single machine, while in some other or similar embodiments, server machines 170 and 180, as well as predictive server 112, can be integrated into a single machine.

In general, functions described in one implementation as being performed by server machine 170, server machine 180, and/or predictive server 112 can also be performed on client device 120. In addition, the functionality attributed to a particular component can be performed by different or multiple components operating together.

In embodiments, a “user” can be represented as a single individual. However, other embodiments of the disclosure encompass a “user” being an entity controlled by one or more users and/or an automated source. For example, a set of individual users federated as a group of administrators can be considered a “user.”

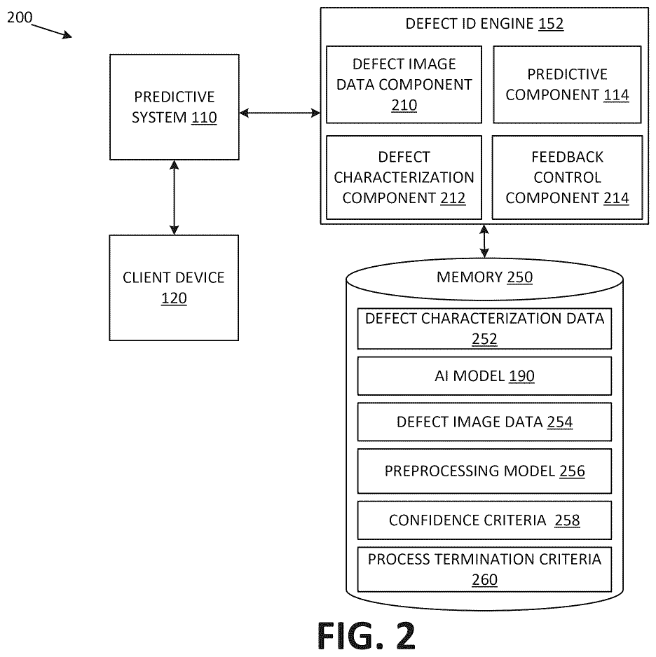

FIG. 2 is a block diagram of an example defect ID engine 152, according to aspects of the present disclosure. As described above, defect ID engine 152 can obtain defect characterization data 252 associated with a defect detected on a surface of a substrate depicted in one or more images. In some embodiments, the defect ID engine 152 can determine whether a defect is present on the surface of the substrate before obtaining the defect characterization data, including an indication of one or more of defect types and defect sources, for the detected defect. The defect ID engine can provide the indication of one or more defect types and defect sources to a client device 120 for presentation to one or more users. As illustrated by FIG. 2, defect ID engine 152 can include a defect image data component 210, a defect characterization component 212, a predictive component 114, and/or a feedback control component 214. In some embodiments, defect ID engine 152 can be connected to the predictive system 110 and/or memory 250 (e.g., via network 130). The predictive system can be connected to a client device 120 in some embodiments (e.g., via network 130). In other or similar embodiments, memory 250 can include any memory of or accessible to a component of system 100. For example, memory 250 can include, or be included in, data store 140, a memory of client device 120, and so forth.

As described herein, defect ID engine 152 can obtain defect characterization data for a defect detected on a surface of a substrate depicted by one or more images based on one or more outputs of an AI model 190. The model 190 may be trained based on historical data associated with system 100 (or another system) to predict defect characterization data 252 for a defect based on given defect image data 254 depicting a surface of a substrate. Details regarding training the model 190 are provided herein with respect to FIG. 3.

FIG. 3 is block diagram depicting an example method 300 for training an AI model, according to aspects of the present disclosure. Method 300 is performed by processing logic that can include hardware (circuitry, dedicated logic, etc.), software (such as is run on a general-purpose computer system or a dedicated machine), firmware, or some combination thereof. In one implementation, method 300 can be performed by a computer system, such as computer system architecture 100 of FIG. 1. In other or similar implementations, one or more operations of method 300 can be performed by one or more other machines not depicted in the figures. In some aspects, one or more operations of method 300 can be performed by training set generator 172.

For simplicity of explanation, method 300 is depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 310, processing logic initializes a training set T to an empty set (e.g., {}). At block 312, processing logic identifies one or more historical images depicting a historical defect of a historical substrate processed using one or more manufacturing equipment 124 and/or other manufacturing equipment (e.g., of system 100 or of another system). In some embodiments, processing logic (e.g., training set generator 172) can identify or otherwise obtain the one or more historical images from defect image data 254 of memory 250. In other or similar embodiments, defect image data 254 can be provided by a user of a system 100 (e.g., a user of a client device 120) and/or a developer or operator of system 100 and/or client device 120, in some embodiments. In some embodiments, the one or more historical images can be SEM images. As described above, a SEM image includes a high resolution image obtained using a scanning electron microscope that directs a beam of electrons on a surface of a substrate and detectors that collect the electron signals when the electrons contact the surface of the substrate and convert the signals into an image. In additional or alternative embodiments, defect image data component 210 can perform one or more preprocessing operations with respect to the historical images. Training set generator 172 can retrieve the preprocessed images from defect image data component 210 or memory 250.

Preprocessing operations can increase the resolution of the images and/or remove text, patterns and burnout marks from electron beams (eBeams), and/or particles from the images. Increasing the resolution of the image can include enhancing contrast of an image or increasing pixel density. Removing text includes removing text in the image, such as text labels indicating the date and time an image was captured. In some embodiments, preprocessing operations can also include removing patterns (e.g., distinct shapes or structures from scanning lines or areas where the eBeam interacts with the surface of the substrate) or burnout marks (e.g., damage caused by excessive eBeam exposure that melts or degrades the surface of the substrate) caused by eBeams from SEM imaging or other manufacturing processes. Removing particles from images includes removing unwanted dust particles or non-organic contaminants (e.g., metallic droplets, glass beads, ceramic particles) depicted in the images.

In some embodiments, defect image data component 210 can perform the preprocessing operations using one or more separate AI models trained to perform one or more tasks pertaining to the respective preprocessing operations. Such models are referred to as preprocessing models 256 here. Depending on the embodiment, one preprocessing model 256 can perform multiple preprocessing operations. In some embodiments, the one or more preprocessing models 256 may be stored on memory 250.

As described herein, the AI model can be further trained to predict whether an unknown surface feature corresponds to a defect. In such embodiments, training set generator 172 may identify one or more historical images of a historical substrate that do not depict defects (e.g., a film intentionally patterned for the purpose of photolithography). As described above, the one or more historical images can be obtained from defect image data 254 stored in memory 250 or provided by a user of a system 100 (e.g., a user of a client device 120) and/or a developer or operator of system 100 and/or client device 120.

At block 314, processing logic obtains historical defect characterization data associated with the one or more historical images depicting the historical defect of the historical substrate. Historical defect characterization data can include an indication of a defect type and an indication of a defect source associated with the historical defect. In some embodiments, the historical defect characterization data can be identified from defect characterization data 252 stored at memory 250. For example, one or more processing devices can extract image descriptors (e.g., shape, size, location, etc.) of one or more image features depicted by the one or more historical images from the metadata of the one or more historical images. The image descriptors of the one or more historical images can be compared with image descriptors of one or more reference images that depict known defects from defect image data 254 to determine whether the historical images depict a defect. In some embodiments, one or more processing devices can generate image vectors, or one-dimensional arrays where each element of the array contains a numerical value that represents the characteristics (e.g., the intensity or brightness) of a pixel in the image, to represent the features of the one or more historical images through numerical values that describe each pixel of the historical images. The image vectors can be compared (e.g., using cosine similarity, Euclidean distance, etc.) with image vectors from reference images depicting known defects from defect image data 254 to determine whether the historical images depict a defect. Processing logic then identifies the defect characterization data (e.g., from defect characterization data 252 stored in memory 250) associated with the reference images that have the most similar characteristics to the historical defect. In other embodiments, a user (e.g., an engineer, an operator, etc.) can provide the defect characterization data via a user interface (UI) of a client device 120.

In some embodiments, a user manually provides the defect characterization data for the reference images via a UI of a client device 120. For example, a user can manually assign labels associated with a defect type and defect source to each reference image. In other embodiments, the defect characterization data for the reference images is assigned based on historical or experimental data collected for the system 100. In some embodiments, the data can be collected using a data acquisition system that can collect sensor data and/or user inputs. For example, a user can manually input data regarding the defect source and defect type for a defect, which is stored in the data acquisition system. In other embodiments, the computing system 150 can use sensor data collected from different components of the manufacturing equipment 124 before and after a process to determine the defect source and defect type. Based on the data, the computing system 150 can identify patterns (e.g., a shape or size) for a surface feature on a substrate and the associated defect type and defect source and use the patterns to assign labels to the reference images. In some embodiments, the computing system 150 can request for a user to confirm the determined defect source and defect type before it is assigned to a reference image.

As indicated above, in some embodiments, the AI model can be further trained to predict whether a surface feature on a substrate corresponds to a defect. In such an embodiment, historical defect characterization data also includes an indication of whether an image of a surface feature of a substrate depicts a defect. As described above, the AI model may be trained to compare a historical image against reference images from defect image data 254 to identify reference images with similar characteristics (e.g., by comparing image descriptors or vectors). Processing logic then identifies, based on the similar reference images, historical defect characterization data for the one or more historical images from the defect characterization data 252 stored in memory 250. In some embodiments, a user may provide the defect data via a UI of a client device 120.

At block 316, processing logic generates a training input based on the identified one or more historical images. In some embodiments, the training input includes the one or more historical images or the portions of the one or more historical images that depict the defect. In other embodiments, the training input can include image feature data (e.g., image descriptors or image vectors) extracted from portions of the one or more historical images that depict the defect. In some embodiments, the one or more historical images can depict a historical defect on a surface of a historical substrate. In other or similar embodiments where the AI model is also capable of predicting whether a surface feature corresponds to a defect, the one or more images can depict a historical feature on a surface of a historical substrate that is not a defect, such as a passivation layer.

At block 318, processing logic generates a target output based on the identified historical defect characterization data. In some embodiments, the target output can include an indication of one or more defect types and a defect source associated with each defect type, as included with defect characterization data 252 for the one or more historical images depicting a historical defect. In other or similar embodiments, the target output can also include an indication of whether a surface feature depicted in the one or more historical images corresponds to a defect, as included with defect characterization data 252.

At block 320, processing logic generates a mapping between the training input and the target output. At block 322, processing logic adds the mapping to the training set T. At block 324, processing logic determines whether the training set T includes a sufficient amount of training data to train an AI model. It should be noted that in some implementations, the sufficiency of training set T can be determined based simply on the number of mappings in the training set, while in some other implementations, the sufficiency of training set T can be determined based on one or more other criteria (e.g., a measure of diversity of the training examples, etc.) in addition to, or instead of, the number of input/output mappings. Responsive to determining the training set does not include a sufficient amount of training data to train the AI model, method 300 returns to block 312. Responsive to determining the training set, T, includes a sufficient amount of training data to train the AI model, method 300 continues to block 326.

At block 326, processing logic provides training set T to train the AI model. In one implementation, the training set T is provided to training engine 182 of server machine 180 to perform the training. In the case of a neural network, for example, input values (e.g., the training input) of a given input/output mapping are input to the neural network, and output values (e.g., the target output) of the input/output mapping are stored in the output nodes of the neural network. The connection weights in the neural network are then adjusted in accordance with a learning algorithm (e.g., backpropagation, etc.), and the procedure is repeated for the other input/output mappings in the training set T. After block 326, the model 190 can be used to predict defect characterization data of a current substrate processed using manufacturing equipment 124, as described herein.

Referring back to FIG. 2, the defect ID engine 152 can determine whether a defect is present on a surface of a substrate and, if so, determines a defect type and/or a defect source at manufacturing equipment 124 based on one or more outputs of the model 190. Embodiments relating to determining the indication of one or more defect types and defect sources for the defect depicted in the one or more images and providing the indication of one or more defect types and associated defect sources are described with respect to FIG. 2, and 4.

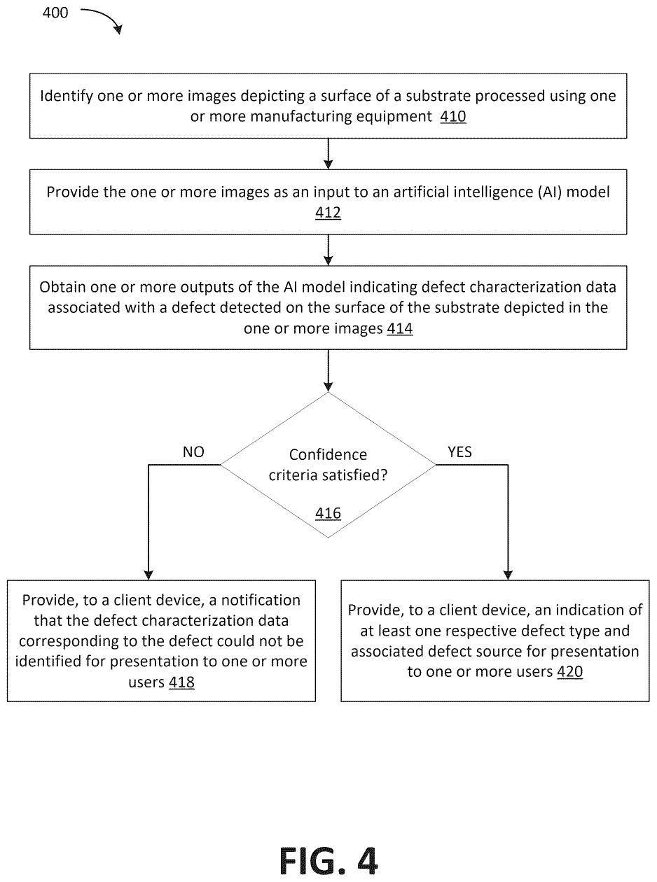

FIG. 4 is a flow chart of an example method 400 for organic defect source identification using AI, according to aspects of the present disclosure. Method 400 is performed by processing logic that can include hardware (circuitry, dedicated logic, etc.), software (such as is run on a general-purpose computer system or a dedicated machine), firmware, or some combination thereof. In one implementation, method 400 can be performed by a computer system, such as computer system architecture 100 of FIG. 1. In other or similar implementations, one or more operations of method 400 can be performed by one or more other machines not depicted in the figures. In some aspects, one or more operations of method 300 can be performed by defect ID engine 152 and/or predictive component 114.

For simplicity of explanation, method 400 is depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 410, processing logic identifies one or more images depicting a surface of a substrate processed using one or more manufacturing equipment 124. In some embodiments, the one or more images may depict a surface feature of a substrate processed using one or more manufacturing equipment 124 (e.g., and it is unknown to the system whether such surface feature is a defect). In other or similar embodiments, defect image data component 210 can identify one or more images that depict a defect (e.g., as specified by a user of system) and select such images to be provided as an input to AI model 190. Processing logic (e.g., defect image data component 210) can identify the one or more images based on defect image data 254 at memory 250, in some embodiments. In some embodiments, the one or more images can be SEM images.

In other or similar embodiments, the defect image data component 210 can perform one or more preprocessing operations on the one or more images in accordance with embodiments described with respect to FIG. 3. As described above, in some embodiments, the one or more preprocessing operations can be performed by one or more separate AI models (e.g., preprocessing models 256). In some embodiments, the defect image data component 210 can provide a UI to a client device 120 for presentation to one or more users. The UI can contain one or more UI elements (e.g., checkboxes, buttons, switches, etc.) that each pertain to a preprocessing operation. Upon detection of a user selection of a respective UI element (e.g., marking the checkbox or pressing the button) pertaining to a preprocessing operation to improve the resolution of the one or more images, the defect image data component 210 can identify a preprocessing model 256 associated with the respective preprocessing operation. Defect image data component 210 then provides the one or more images to the identified preprocessing model 256, which performs the preprocessing operation on the one or more images. Defect image data component 210 then receives one or more outputs of the preprocessing model 256, which includes one or more enhanced images that have or are associated with an image resolution that is higher than the image resolution of the one or more images that were input into the preprocessing model 256.

In some embodiments, the defect image data component 210 can perform the preprocessing operations without input from a user. For example, defect image data component 210 can perform a preprocessing analysis operation to determine one or more flaws associated with the one or more images. In some embodiments, the preprocessing analysis operation can be performed by a separate AI model. Based on the outputs of the preprocessing analysis operation indicating one or more flaws, the defect image data component 210 can determine one or more preprocessing operations to perform by identifying the preprocessing operations that can mask the one or more flaws. In some embodiments, the one or more preprocessing operations can be determined using a separate AI model. Depending on the embodiment, one separate AI model can perform the preprocessing analysis operation and determine the one or more preprocessing operations to perform. The defect image data component 210 can identify one or more preprocessing models 256 capable of performing the one or more preprocessing operations and provide the one or more images as input to the identified preprocessing models 256.

At block 412, processing logic provides the one or more images as an input to an AI model. In some embodiments, predictive component 114 of defect ID engine 152 can provide the one or more images as the input to the model 190, in accordance with described embodiments. The model 190 can be trained to detect a defect on a surface of a substrate depicted by one or more given images and can determine defect characterization data for the detected defect, as described herein.

At block 414, processing logic obtains one or more outputs of the AI model. In some embodiments, the one or more outputs can indicate whether a defect is detected on a surface of the substrate and, in additional or alternative embodiments, can indicate defect characterization data associated with the detected defect depicted in the one or more images. As described herein, defect characterization data 252 can include an indication of one or more defect types, a defect source associated with each defect type, and a level of confidence that each defect type and associated defect source correspond to the defect depicted in the one or more images. In some embodiments, the defect characterization data can also include an indication of whether the surface feature depicted in the one or more images corresponds to a defect.

At block 416, processing logic determines whether the level of confidence associated with at least one defect type and associated defect source satisfies one or more confidence criteria. In some embodiments, defect characterization component 212 can identify one or more confidence criteria 258 associated with the defect depicted in the image and defect characterization data. Defect characterization component 212 can receive a notification of confidence criteria 258 from a client device 120 associated with a user of system 100, in some embodiments. In other embodiments, the defect characterization component 212 may identify confidence criteria 258 from a data store that includes confidence criteria. In other or similar embodiments, confidence criteria 258 may be embedded in the code (e.g., hard-coded) of the defect characterization component 212.

In some embodiments, the defect characterization component 212 can determine whether a defect type and associated defect source from the defect characterization data 252 satisfies the confidence criteria 238 by determining whether the level of confidence associated with each defect type and associated defect source satisfies a threshold level of confidence, as defined by the confidence criteria 258. In other embodiments, the defect characterization component 212 can identify one or more defect types and associated defect sources that satisfy the confidence criteria 258 by determining an ordering associated with the levels of confidence of each defect type and associated defect source (e.g., from highest to lowest) and identifying the ordered defect types and associated defect sources that exceed a certain threshold (e.g., within the top five highest levels of confidence). In other or similar embodiments, the defect characterization component 212 can first determine whether a defect is present on the surface of the substrate depicted in the one or more images based on the defect characterization data 252 satisfying the confidence criteria 258. If the defect characterization component 212 determines that a defect is present, the defect characterization component determines defect characterization data for the determined defect through the process described above. In some embodiments, the defect characterization component 212 can determine that the confidence criteria 258 are satisfied upon determining that the level of confidence of one or more defect types and associated defect sources meet a threshold and/or determining that the surface feature depicted in the one or more images corresponds to a defect.

Upon a determination that the one or more confidence criteria are not satisfied, method 400 proceeds to block 418. At block 418, processing logic provides, to a client device 120, a notification for presentation to one or more users of the client device 120 that the defect characterization data corresponding to the defect could not be identified. In some embodiments, the processing logic can provide a notification that a defect was not detected on the surface of the substrate depicted in the one or more images to a client device 120 for presentation to one or more users. In some embodiments, upon a determination that a defect could not be identified, defect ID engine 152 can provide a notification to a system controller associated with manufacturing equipment 124 indicating that no defect was identified. In some embodiments, system controller can update a defect log (not shown) associated with manufacturing equipment 124 to indicate that no defect is present. Accordingly, the system controller can perform operations that enable the manufacturing equipment 124 to continue processing substrates using manufacturing equipment 124 (e.g., according to the same or a similar process recipe used to process the substrate for which images were identified at block 410).

Upon a determination that the one or more confidence criteria are satisfied, method 400 proceeds to block 420. At block 420, processing logic provides, to a client device 120, an indication of at least one respective defect type and associated defect source for presentation to one or more users. In some embodiments, the processing logic may determine an ordering associated with the one or more defect types and associated defect source based on the level of confidence for each defect type and associated defect source. For example, the defect types and associated defect sources can be ordered from highest level of confidence to lowest level of confidence. The one or more defect types and associated defect sources may be provided to a client device 120 for presentation to one or more users in accordance with the ordering.

In some embodiments, a feedback control component 214 can determine one or more defect correction operations to be performed to correct a defect based on the one or more defect types and associated defect sources. In some embodiments, defect correction operations stored in a database (e.g., memory 250) can be associated with a defect type and a defect source. The feedback control component 214 can determine the one or more defect correction operations in the database by identifying the associated defect types and defect sources that correspond to the indicated one or more defect types and defect sources. For example, a feedback control component 214 can determine a need to replace a filter in a diffuser based on a determination that a defect is caused by organic vapors that were not effectively filtered and thus deposited unevenly on a substrate surface. The one or more defect correction operations can be provided to client device 120 for presentation to one or more users, in some embodiments. In other or similar embodiments, feedback control component 214 can perform the one or more defect correction operations (e.g., with or without user intervention). For example, if a defect is caused by residue from the walls of a process chamber used for chemical vapor deposition or plasma etching settling on the surface of a substrate, the feedback control component 214 can initiate a plasma cleaning of the process chamber to remove the residue from the walls of the process chamber.

In other or similar embodiments, the feedback control component 214 may also determine whether a defect type and associated defect source satisfy one or more process termination criteria 260. The process termination criteria can represent conditions under which a manufacturing process is to be terminated (e.g., by a system controller, etc.). Such conditions can include a defect type and defect source impacting the quality of substrates, decreasing a yield, or affecting the safety of a manufacturing process. For example, the feedback control component 214 can determine that a defect caused by the leaking of an organic solvent (e.g., acetone) satisfies the process termination criteria 260, as organic solvents can be harmful if inhaled or absorbed through the skin, posing a significant safety risk. Additionally, feedback control component 214 can determine that the leak satisfies the process termination criteria 260 because the leak is a significant component failure that will cause damage (e.g., surface deformation, surface erosion, etc.) that interferes with the intended functionality of all future substrates processed in the processing chamber, significantly affecting the quality of the substrates and the yield of the system 100. In some embodiments, feedback control component 214 can receive process termination criteria 260 from a user. In other or similar embodiments, the feedback control component 214 can identify process termination criteria 260 from a data store that includes process termination criteria. For example, the feedback control component can identify process termination criteria 260 from a private data store that stores one or more safety criteria for a manufacturing system.

If the one or more process termination criteria 260 are satisfied, processing logic may perform one or more operations to terminate a substrate process at the manufacturing equipment 124. In some embodiments, the feedback control component 214 can determine that the one or more process termination criteria 260 are satisfied based on a determination that the defect type and associated defect source would significantly impact the quality or yield of a substrate or subsequently processed substrates. For example, a high concentration of organic contamination caused by a diffuser with a worn filter can lead to irreparable damage on the substrate and subsequently processed substrates if the filter is not replaced. As such, the feedback control component 214 can determine that a high concentration of organic contamination caused by a diffuser satisfies the process termination criteria 260 and terminate the diffuser until the filter can be replaced. In other embodiments, the feedback control component 214 can determine that the process termination criteria 260 are satisfied by comparing the frequency of identical classifications of a defect type and associated defect source for different substrates and determining if the frequency exceeds a threshold within a specified time window or within a certain number of classifications. For example, the process termination criteria 260 may be satisfied if the same defect type and associated source of the defect is determined for 10 substrates within an hour or if 10 of the last 20 inspected substrates were determined to have the same defect type and associated defect source. In some embodiments, the process termination criteria 260 are satisfied upon determining that the one or more defect types and associated defect sources will significantly impact quality or yield of the substrate or subsequently processed substrates and/or determining that the frequency of identical classifications exceeds a certain threshold. As described herein, the process termination criteria can also be satisfied upon a determination that the one or more defect types and defect sources pose a safety risk to the manufacturing system, in some embodiments.

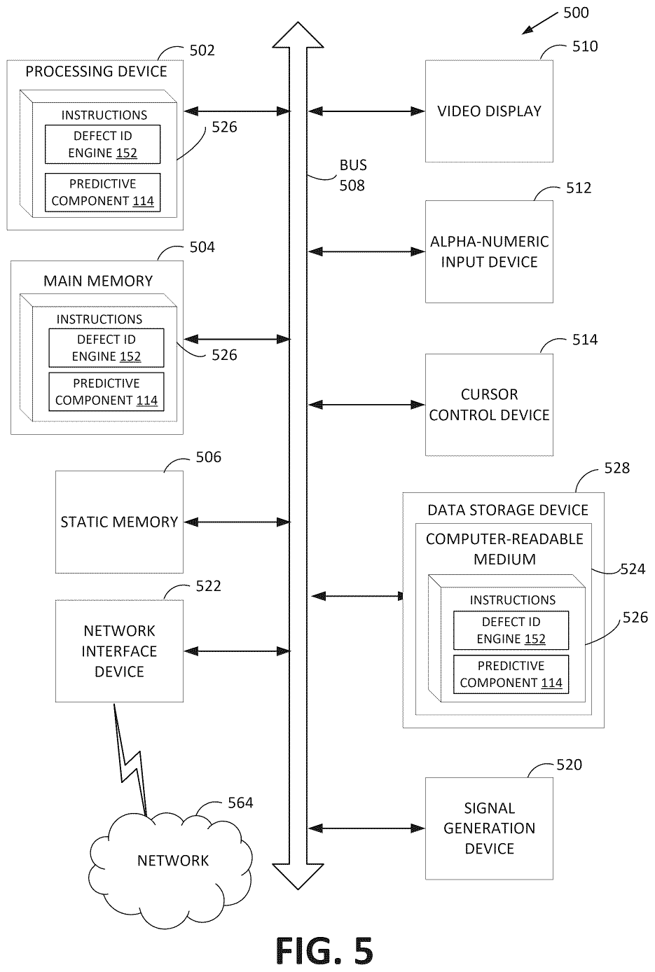

FIG. 5 depicts a block diagram of an illustrative computer system 500 operating in accordance with one or more aspects of the present disclosure. In alternative embodiments, the machine can be connected (e.g., networked) to other machines in a Local Area Network (LAN), an intranet, an extranet, or the Internet. The machine can operate in the capacity of a server or a client machine in a client-server network environment, or as a peer machine in a peer-to-peer (or distributed) network environment. The machine can be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In embodiments, computing device 500 can correspond to predictive server 112 of FIG. 1 or another processing device of system 100. In other or similar embodiments, computing device 500 can correspond to computing system 150 of system 100.

The example computing device 500 includes a processing device 502, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 528), which communicate with each other via a bus 508.

Processing device 502 can represent one or more general-purpose processors such as a microprocessor, central processing unit, or the like. More particularly, the processing device 502 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. Processing device 502 can also be or include a system on a chip (SoC), programmable logic controller (PLC), or other type of processing device. Processing device 502 is configured to execute the processing logic for performing operations and steps discussed herein.

The computing device 500 can further include a network interface device 522 for communicating with a network 564. The computing device 500 also can include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 528 can include a machine-readable storage medium (or more specifically a non-transitory computer-readable storage medium) 524 on which is stored one or more sets of instructions 526 embodying any one or more of the methodologies or functions described herein. A non-transitory storage medium refers to a storage medium other than a carrier wave. The instructions 526 can also reside, completely or at least partially, within the main memory 504 and/or within the processing device 502 during execution thereof by the computer device 500, the main memory 504 and the processing device 502 also constituting computer-readable storage media.

The computer-readable storage medium 524 can also be used to store model 190 and data used to train model 190. The computer readable storage medium 524 can also store a software library containing methods that call model 190. While the computer-readable storage medium 524 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of operations of each method can be altered so that certain operations can be performed in an inverse order so that certain operations can be performed, at least in part, concurrently with other operations. In another embodiment, instructions or sub-operations of distinct operations can be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying one or more images depicting a surface of a substrate processed using one or more manufacturing equipment;
providing the one or more images as an input to an artificial intelligence (AI) model;
obtaining one or more outputs of the AI model, wherein the one or more outputs comprise defect characterization data associated with a defect detected on the surface of the substrate depicted by the one or more images, wherein the defect characterization data comprises:
an indication of a plurality of defect types and, for each of the plurality of defect types, an indication of a defect source at the one or more manufacturing equipment in view of a respective defect type, and
for each of the plurality of defect types, a level of confidence that the respective defect type and associated defect source correspond to the defect detected on the surface of the substrate; and
responsive to determining that a level of confidence associated with at least one respective defect type and associated defect source satisfies one or more confidence criteria, providing, to a client device, an indication of the at least one respective defect type and associated defect source for presentation to one or more users.

2. The method of claim 1, further comprising:
prior to providing the one or more images as the input to the AI model, performing one or more preprocessing operations on the one or more images, wherein the one or more preprocessing operations comprise at least one of:
increasing a resolution of the one or more images, or
removing one or more of text, patterns, burnout marks, or particles depicted by the one or more images.

3. The method of claim 2, wherein a respective preprocessing operation of the one or more preprocessing operations is associated with a separate AI model trained to perform one or more tasks pertaining to the respective preprocessing operation.

4. The method of claim 2, further comprising:
providing a user interface (UI) for the client device for presentation to the one or more users, wherein the UI comprises one or more UI elements each corresponding to a respective preprocessing operation of the one or more preprocessing operations,
wherein the respective preprocessing operation of the one or more preprocessing operations is performed responsive to detection of a user selection of a corresponding UI element of the one or more UI elements.

5. The method of claim 1, wherein the one or more images comprise scanning electron microscopy (SEM) images.

6. The method of claim 1, further comprising:
determining an ordering associated with each of the plurality of defect types and associated defect source based on the level of confidence for each respective defect type and associated defect source,
wherein each of the plurality of defect types and associated defect source are provided for presentation to the one or more users in accordance with the determined ordering.

7. The method of claim 1, wherein the defect is an organic defect.

8. The method of claim 1, further comprising:
determining one or more defect correction operations to be performed to correct the defect based on the at least one respective defect type and the associated defect source; and
providing an indication of the determined one or more defect correction operations to the client device for presentation to the one or more users.

9. The method of claim 1, further comprising:
determining, based on the indication of the at least one respective defect type and the associated defect source, that one or more process termination criteria are satisfied; and
performing one or more operations to terminate a substrate process for the substrate or one or more additional substrates at the one or more manufacturing equipment.

10. A system comprising:
a memory; and
a set of one or more processing devices coupled to the memory, wherein the set of one or more processing devices is to:
generate training data for training an artificial intelligence (AI) model to predict current defect characterization data for a defect detected on a surface of a current substrate depicted by current images of the current substrate processed using one or more first manufacturing equipment, wherein to generate the training data, the set of one or more processing devices is to:
generate a training input comprising one or more historical images depicting a historical defect on a surface of a historical substrate processed using one or more second manufacturing equipment;
generate a target output for the training input, wherein the target output comprises historical defect characterization data comprising an indication of a defect type for the historical defect and an indication of a defect source associated with the historical defect at the one or more second manufacturing equipment in view of the defect type; and
provide the training data to train the AI model on (i) a set of training inputs comprising the training input and (ii) a set of target outputs comprising the target output.

11. The system of claim 10, wherein the set of one or more processing devices is further to:
extract, from metadata associated with the one or more historical images, one or more image descriptors of the one or more historical images;
identify one or more image descriptors associated with one or more defect types; and
determine, based on the one or more image descriptors of the one or more historical images and the one or more image descriptors of the one or more defect types, the defect type for the historical defect and an associated source of the historical defect in view of the defect type.

12. The system of claim 10, wherein defect type is one of a lubricant, photoresist residue, cleaning solvent residue, chemical solvent residue, a polymer film, a chemical vapor, or an airborne contaminant.

13. The system of claim 10, wherein the defect source is one of a robot adaptor, a diffusion tool, a packaging tool, a hot plate, a lithography tool, a cleaning tool, a deposition tool, a metrology tool, or an etching tool.

14. The system of claim 10 wherein the one or more historical images are preprocessed, wherein preprocessing comprises at least one of:
increasing a resolution of the one or more images, or
removing one or more of text, patterns, burnout marks, or particles depicted by the one or more images.

15. The system of claim 10, wherein the historical defect is an organic defect.

16. The system of claim 10, wherein the one or more historical images further comprise scanning electron microscopy (SEM) images.

17. A non-transitory computer readable medium comprising instructions that, when executed by a set of one or more processing devices, cause the set of one or more processing devices to:
identify one or more images depicting a surface of a substrate processed using one or more manufacturing equipment;
provide the one or more images as an input to an artificial intelligence (AI) model;
obtain one or more outputs of the AI model, wherein the one or more outputs comprise defect characterization data associated with a defect detected on the surface of the substrate depicted by the one or more images, wherein the defect characterization data comprises:
an indication of a plurality of defect types and, for each of the plurality of defect types, an indication of a defect source at the one or more manufacturing equipment in view of a respective defect type, and
for each of the plurality of defect types, a level of confidence that the respective defect type and associated defect source correspond to the defect detected on the surface of the substrate; and
responsive to determining that a level of confidence associated with at least one respective defect type and associated defect source satisfies one or more confidence criteria, provide, to a client device, an indication of the at least one respective defect type and associated defect source for presentation to one or more users.

18. The non-transitory computer readable medium of claim 17, wherein the set of one or more processing devices is further to:
prior to providing the one or more images as the input to the AI model, perform one or more preprocessing operations on the one or more images, wherein the one or more preprocessing operations comprise at least one of:
increasing a resolution of the one or more images, or
removing one or more of text, patterns, burnout marks, or particles depicted by the one or more images,
and wherein a respective preprocessing operation of the one or more preprocessing operations is associated with a separate AI model trained to perform one or more tasks pertaining to the respective preprocessing operation; and
provide a user interface (UI) for the client device for presentation to the one or more users, wherein the UI comprises one or more UI elements each corresponding to a respective preprocessing operation of the one or more preprocessing operations,
wherein the respective preprocessing operation of the one or more preprocessing operations is performed responsive to detection of a user selection of a corresponding UI element of the one or more UI elements.

19. The non-transitory computer readable medium of claim 17, wherein the set of one or more processing devices is further to:
determine an ordering associated with each of the plurality of defect types and associated defect source based on the level of confidence for each respective defect type and associated defect source,
wherein each of the plurality of defect types and associated defect source are provided for presentation to the one or more users in accordance with the determined ordering.

20. The non-transitory computer readable medium of claim 17, wherein the set of one or more processing devices is further to:
determine one or more defect correction operations to be performed to correct the defect based on the at least one respective defect type and the associated defect source; and
provide an indication of the determined one or more defect correction operations to the client device for presentation to the one or more users.
